(19) United States
(12) Patent Application Publication
(10) Pub. No.: US 2008/0007130 A1
(43) Pub. Date: Jan. 10, 2008

(54) Motor using magnetic normal force

(76) Inventor: Jonathan Sidney Edelson, Portland, OR (US)

Correspondence Address: BOREALIS TECHNICAL LIMITED, 23545 NW SKYLINE BLVD, NORTH PLAINS, OR, 97133-9204, US

(21) Appl. No.: 11/900,475

(22) Filed: Sep. 11, 2007

Related U.S. Application Data
(63) Continuation-in-part of application No. PCT/US2007/005523, filed on Mar. 2, 2007.
(60) Provisional application No. 60/843,933, filed on Sep. 11, 2006.
(60) Provisional application No. 60/778,667, filed on Mar. 3, 2006.

(51) Int. Cl. H02K 37/14; H02K 7/10; H02K 7/06

(52) U.S. Cl. 310/82; 310/49 R; 310/83; 74/640; 310/75 R

(57) ABSTRACT

A motor is disclosed, comprising at least one fixed member comprising at least one magnetic winding, having an internal cavity; at least one driven member inside said fixed member, comprising magnetically conductive materials; constraining means for constraining said driven member to a path of movement with respect to said fixed member, said driven member being able to move within said fixed member, wherein magnetic normal force is induced in said fixed member periodically, whereby said driven member is periodically moved around said path by magnetic force, whereby rotary motion is produced.

### CROSS-REFERENCE TO RELATED APPLICATIONS

This application claims the benefit of U.S. Provisional Patent Application No. 60/843,933, filed Sep. 11, 2006, and is a Continuation-in-part of International Patent Application No. PCT/US2007/05523, filed Mar. 2, 2007, which designates the United States. Said International Patent Application No. PCT/US2007/05523 claims the benefit of U.S. Provisional Patent Application No. 60/778,667, filed Mar. 3, 2006. The aforementioned documents are herein incorporated in their entirety by reference.

### BACKGROUND OF THE INVENTION

The invention relates to motors able provide high torque at low speed, and in particular to the use of radial magnetic force in such motors.

Motor-Generator machines able to provide high torque at low speed, which are compact, are disclosed in the art.

WO05112584 discloses a motor-generator machine comprising a slotless AC induction motor. The motor disclosed therein is an AC induction machine comprising an external electrical member attached to a supporting frame and an internal electrical member attached to a supporting core; one or both supports are slotless, and the electrical member attached thereto comprises a number of surface mounted conductor bars separated from one another by suitable insulation. An airgap features between the magnetic portions of core and frame. Electrical members perform the usual functions of rotor and stator but are not limited in position by the present invention to either role. The stator comprises at least three different electrical phases supplied with electrical power by an inverter. The rotor has a standard winding configuration, and the rotor support permits axial rotation.

WO2006/002207 discloses a motor-generator machine comprising a high phase order AC machine with short pitch winding. Disclosed therein is a high phase order alternating current rotating machine having an inverter drive that provides more than three phases of drive waveform of harmonic order H, and characterized in that the windings of the machine have a pitch of less than 180 rotational degrees. Preferably the windings are connected together in a mesh, star or delta connection. The disclosure is further directed to selection of a winding pitch that yields a different chording factor for different harmonics. The aim is to select a chording factor that is optimal for the desired harmonics.

WO2006/065988 discloses a motor-generator machine comprising stator coils wound around the inside and outside of a stator, that is, toroidally wound. The machine may be used with a dual rotor combination, so that both the inside and outside of the stator may be active. Even order drive harmonics may be used, if the pitch factor for the windings permits them. In a preferred embodiment, each of the coils is driven by a unique, dedicated drive phase. However, if a number of coils have the same phase angle as one another, and are positioned on the stator in different poles, these may alternatively be connected together to be driven by the same drive phase. In a preferred embodiment, the coils are connected to be able to operate with 2 poles, or four poles, under H=1 where H is the harmonic order of the drive waveform. The coils may be connected together in series, parallel, or anti-parallel.

U.S. Patent Appl. Pub. No. 2006/0273686 discloses a motor-generator machine comprising a polyphase electric motor which is preferably connected to drive systems via mesh connections to provide variable V/Hz ratios. The motor-generator machine disclosed therein comprises an axle; a hub rotatably mounted on said axle; an electrical induction motor comprising a rotor and a stator; and an inverter electrically connected to said stator; wherein one of said rotor or stator is attached to said hub and the other of said rotor or stator is attached to said axle. Such a machine may be located inside a vehicle drive wheel, and allows a drive motor to provide the necessary torque with reasonable system mass.

WO2006/113121 discloses a motor-generator machine comprising an induction and switched reluctance motor designed to operate as a reluctance machine at low speeds and an inductance machine at high speeds. The motor drive provides more than three different phases and is capable of synthesizing different harmonics. As an example, the motor may be wound with seven different phases, and the drive may be capable of supplying fundamental, third and fifth harmonic. The stator windings are preferably connected with a mesh connection. The system is particularly suitable for a high phase order induction machine drive systems of the type disclosed in U.S. Pat. Nos. 6,657,334 and 6,831,430. The rotor, in combination with the stator, is designed with a particular structure that reacts to a magnetic field configuration generated by one drive waveform harmonic. The reaction to this harmonic by the rotor structure produces a reluctance torque that rotates the rotor. For a different harmonic drive waveform, a different magnetic field configuration is produced, for which the rotor structure defines that substantially negligible reluctance torque is produced. However, this magnetic field configuration induces substantial rotor currents in the rotor windings, and the currents produce induction based torque to rotate the rotor. The above five patents describe motors which produce high torque as a low speed overload condition.

In a conventional electric induction motor, an alternating current induces a magnetic field in a stator, causing a rotating radial magnetic force which attracts the rotor to the stator. The rotating magnetic field in the stator induces currents in the rotor. The rotor and stator currents interact to produce a tangential magnetic field and therefore a tangential force. This tangential force is between 1 and 10% of the radial magnetic force between rotor and stator. A typical tangential force per unit area is 2PSI. The tangential force drives the rotor. The much larger radial force is balanced by the rotational symmetry of the apparatus and therefore causes no motion. If unbalanced, the radial force would act to move the rotor towards the stator until it meets. In a non-rotationally symmetric motor, this would result in a self-destructive system. Therefore, non-rotationally symmetric motors require bearings to balance the radial force.

Note that magnetic normal force causes work to be done by way of relative motion between a magnet (or piece of ferromagnetic material such as plain steel) and a magnetic field. Once the rotor and stator are in contact, no further motion is possible and no further work is done. Further note that the strength of a magnetic force depends upon the magnetic flux density, which itself depends upon the distance between the magnetic materials, ie the rotor and stator in a conventional motor. Over a large airgap, a large magnetic flux density cannot be sustained, and thus the normal force is reduced.

The use of gears alongside motors is known in the art. Motors use gears to increase or decrease the output speed or torque, to alter the direction of rotation, or to link multiple elements, for example.

US2006/111214 (Yan and Wu) discloses a geared motor includes a rotor mounted rotatably to a motor housing and having an output shaft along a rotating axis, and a stator secured to the motor housing to surround the rotor. The stator has a plurality of angularly displaced core segments with wall areas confronting magnetic pole units on the rotor, and a plurality of windings wound respectively around the core segments to create a torque so as to drive the output shaft. A planetary gear assembly includes a sun wheel mounted on the output shaft, an annulus secured to the motor housing and having an internally toothed annular surface, and a planet wheel meshing with the toothed surface and the sun wheel. A rotary member is rotated by a speed reduction drive transmitted from the planet wheel about a transmitting axis aligned with the rotating axis.

GB1438555 (RCA Corp) discloses a system for rotating the antenna mast of a television set and providing a local indication of its rotated position. The system comprises a split-phase A.C. induction motor driving through a gear train the shaft of the mast and a cam controlling a changeover switch.

U.S. Pat. No. 4,122,377 to Drummond discloses a drive unit comprising two induction motors mounted side-by-side in a housing. Each induction motor has a stator element and a rotor element, which elements are suitably journaled so that both stator elements and both rotor elements are rotatable. The stator elements are mechanically linked by a gear train so that rotation of one stator element opposes rotation of the other stator element when both induction motors are energized. Therefore, the stator elements buck one another and induce torque in the rotor elements.

The article entitled Digital control and optimization of a rolling rotor switched reluctance machine, Reinert 1995, discloses a motor having a rotor which is free to roll on the inside of the stator. It uses axial tangential forces between rotor and stator, and gear teeth which are spatially distinct from the stator.

G.B. Patent No. 883884 to Rosain discloses an eccentric rotor rolling inside a stator with a complex suspension arrangement to enable the oscillating motion to be absorbed. The rotor rollers have rubber tires.

Japanese Patent No. 2006234005 to Hazama discloses a speed reducer having a rotor having a driven portion concentric with the stator, driven by tangential magnetic force, and a separate eccentric portion which rolls on the inside of the stator to produce a reduced speed.

G.B. Patent No. 2340669 to Inkster discloses a rolling rotor motor which uses radial magnetic force from sequential energization of solenoids around a stator to cause motion of the rotor. The rotor is constrained into a circular region by transfer means or a flexible coupling and held in a circular path by the same radial magnetic force which causes the motion.

U.S. Pat. No. 3,770,997 to Presley discloses a rotory actuator which has a rotor constrained to orbit an eccentric by magnetic forces. Presley uses magnetic ring elements to create ‘hold-in force’. The ring elements contact the rotor at the point where it contacts the stator, which extra mechanical contact is a disadvantage since it will cause friction and wear and tear.

U.S. Pat. No. 2,857,536 to Light discloses a variable reluctance machine with an eccentric shaft and hypocycloidal gearing. Light depends upon magnetic forces to constrain the rotor to wobbling, thus using magnetic force to overcome gear separation forces.

U.S. Pat. No. 2,561,890 to Stoddard discloses a ‘Dynamoelectric machine’ wherein an eccentric rotor is pulled around directly by magnetic flux, for the purpose of operating as a pump. The rotor (movable member 11) is axially displaced from the stator (stationary member 10 having chamber 10a formed by cylindrical brass sleeve 12) with sleeve 12 extending axially from inside stator 10, to form a chamber 10a, part of which is axially displaced from stator 10.

### BRIEF SUMMARY OF THE INVENTION

It can be seen from the forgoing that it would be advantageous to harness the strong radial magnetic force present in the steel core of conventional induction motors, and use it to drive an induction motor, instead of using the smaller tangential force produced in the windings. This is an object of the present invention.

It would be further advantageous to do so without creating unbalanced forces which require bearings to prevent the motor from becoming unbalanced. This is a further object of the present invention.

It would be further advantageous to have an induction motor using gears to modify the speed of rotation, wherein the contact forces and/or speed of rotation of said gears are low, in order to reduce wear and tear of the gear teeth. This is a yet further object of the present invention.

Disclosed is an electric motor and hypocyclic gearing system, wherein magnetic forces are used to directly drive the eccentric or wobbling gear element. In prior art, hypocyclic gearing systems are well known. In such systems, the high-speed input rotates at high speed, driving an eccentric element. This eccentric element further drives a wobbling geared element, which meshes with a stationary gear. The wobbling geared element is thus forced to oscillate or wobble at high speed, while rotating at low speed.

In the method of the present invention, the high speed input and eccentric conversion device is eliminated. Instead the wobbling geared element is directly driven by magnetic forces. Eccentric bearing elements are removed from the system, and stresses associated with high-speed operation of the motor are reduced. Owing to the much greater magnetic force in the normal rather than shear direction, torque density of the motor itself is substantially increased.

A motor is disclosed, comprising at least one fixed member comprising at least one magnetic winding, having an internal cavity; at least one driven member inside said fixed member, comprising magnetically conductive materials; constraining means for constraining said driven member to a path of movement with respect to said fixed member, said driven member being able to move within said fixed member, wherein magnetic normal force is induced in said fixed member periodically, whereby said driven member is periodically moved around said path by magnetic force, whereby rotary motion is produced.

The motor of the present invention thereby provides direct conversion of periodic motion to rotary motion, maintaining the small distance, high force nature of the motor to produce low speed, high torque output.

### BRIEF DESCRIPTION OF THE SEVERAL VIEWS OF THE DRAWINGS

The invention shall now be described in detail with reference to the following drawings in which:

FIG. 1 (Prior Art—Background Section) shows a stator of a motor generator machine with regular windings;

FIG. 2 (Prior Art—Background Section) shows a stator with toroidally wound coils;

FIG. 3 shows the preferred arrangement, for absorbing oscillation and transmitting rotation, using coupled pairs of bearings;

FIG. 4 shows an eccentric bearing arrangement, for absorbing oscillation and transmitting rotation;

FIG. 5 shows a bearing arrangement having different sized races, for absorbing oscillation and transmitting rotation;

FIG. 6 shows a conical gear arrangement, for absorbing oscillation and transmitting rotation;

FIG. 7 shows an oversized axial hole arrangement, for absorbing oscillation and transmitting rotation;

FIG. 8 shows a pin and hole arrangement, for absorbing oscillation and transmitting rotation;

FIG. 9 shows the preferred position of gear teeth with respect to magnetic windings, in the first embodiment of the invention;

FIG. 10 shows an arrangement in which a layer of magnetic windings are positioned alongside a gear layer;

FIG. 11 shows an arrangement using horseshoe windings;

FIG. 13 shows an arrangement using radial solenoids to drive the motor;

FIG. 16 shows the second embodiment, in which a flexible spline is used to couple the stator with the output shaft;

FIG. 17 shows the third embodiment, in which planetary gear rotors are used to couple the stator to the output shaft;

FIG. 18 shows the fourth embodiment, in which a floating ring gear rotor is used to couple the stator with the output shaft;

FIG. 19 shows the fifth embodiment, in which toothed gears are used to couple a smooth rotor to the output shaft;

FIG. 20 shows a three dimensional view of the fifth embodiment;

FIG. 21 shows the sixth embodiment, in which two rotors oscillate within two stators 180 degrees out of phase, and are coupled to a toothed gear in between the rotors;

FIG. 22 shows an arrangement in which several layers of the sixth embodiment are joined;

FIG. 23 shows a seventh embodiment, using a ratchet and pawl mechanism; and

FIG. 24 shows a possible arrangement using a cam ring mechanism.

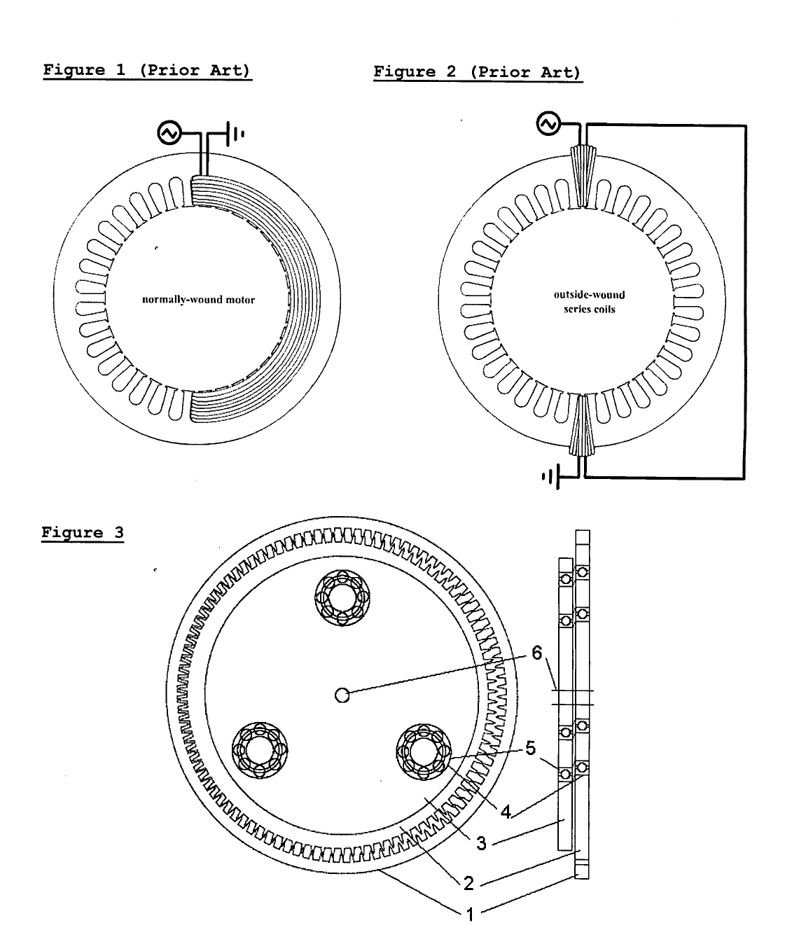

### DETAILED DESCRIPTION OF THE INVENTION

In a first embodiment of the invention, a motor is disclosed, comprising a stator of high permeability material having a magnetic core, magnetic windings, and an internal cavity which is preferably cylindrical; and a rotor made from ferromagnetic materials with high permeability, situated inside the stator. Preferably, said rotor is internal to said stator and said rotor has an outer diameter significantly smaller than the inner diameter of the stator. The outer diameter of the rotor and the inner diameter of the stator have gear teeth so that the rotor and stator mesh as eccentric gears.

Preferably, said windings comprise a set of electrical coils positioned in slots, channels, or cavities in the high permeability material. The coils are arranged to induce a magnetic field in the high permeability material of the rotor and stator and any gap between, thereby creating magnetic attractive force between the rotor and the stator.

During operation, the stator windings are selectively and sequentially energized such that a magnetic normal force is induced around the circumference of the stator, such that the force revolves around the internal cavity of the stator, attracting the rotor to different portions of the stator, whereby the rotor is caused to roll without slipping upon the inner surface of the stator cavity.

The contact patch between the rotor and the stator thus moves in rapid circular periodic motion around the inner circumference of the stator. The rotor rolls on the inside of the stator, thus it oscillates with high frequency and has a slow overall speed and rotational rate.

The interaction between rotor and stator can be explained as follows: In the region of the energized coils, the motion of the rotor is essentially radial, with the rotor moving toward the stator over a short distance with minimal lateral motion. High ‘normal force’ attraction thus causes the motion of the rotor. The size difference between rotor and stator converts this radial motion into rotational motion as the rotor rolls without slipping upon the inner surface of the stator cavity. High torque, low speed rotary motion may be achieved thereby without a requirement for high-speed low torque rotary motion. The rotor will be seen to oscillate at relatively high frequency, but with small displacement and therefore small acceleration, this high frequency small displacement motion being converted to high torque, slow speed rotary motion.

Preferably, said motor comprises constraining means for constraining said driven member to a path of movement with respect to said fixed member. Said constraining means are preferably bearings for constraining the driven member to a fixed path while absorbing oscillation and transmitting rotation. An example of such bearings are those labeled 4 in FIG. 1 and described below. Said constraining means may also be any means for holding said driven member within a path of motion with respect to said driven member. Whenever torque is transmitted through gears, the gear elements develop a separation force, which tends to push the centers of the gears apart. This gear separation force is always present when gears are used. A gear separation force may be described as a force produced by the mechanical action of gearing elements. An advantage of said constraining means is that they overcome gear separation forces between the gear teeth of said fixed and driven members. Without constraining means, the magnetic force would be wasted in overcoming these gear separation forces. Since the motors of the present invention tend to have gears having many teeth which are shallow, and since gear separation forces increase with shallowness of gear teeth, these forces are considerable and the constraining means thus provide a significant advantage.

Alternatively said rotor is external to said stator, said stator is externally toothed, said rotor is internally toothed, and the external diameter of said stator is slightly smaller than the internal diameter of said rotor such that when magnetic normal force is induced around the circumference of the stator, such that the force circles the internal cavity of the stator, said rotor is periodically attracted around the outside of said stator, such that the contact patch between the rotor and the stator moves in rapid circular periodic motion around the outer circumference of the stator, thus oscillating with high frequency and slow overall speed and rotational rate.

An advantage of the present invention is that high torques can be obtained due to the use of radial magnetic force, unlike regular motors which primarily use the much smaller tangential magnetic forces. A further advantage of the invention is that the slow relative speed between components causes minimal wear and tear of the gears and minimal frictional losses. A yet further advantage of the invention is that, due to the gear teeth, high torques can be accommodated without the risk of slip.

A further advantage is that, since the combination of eccentric bearings and gear teeth supporting the rotor constrain said rotor to roll without slipping, there is no dependence on friction for output torque production, which eliminates magnetic effort used to hold the rotor to the stator against gear separation forces, and maintains rotor-stator distance to an optimal value for magnetic and mechanical design.

The first, preferred, embodiment of the invention is shown in FIG. 3. Stator 1 has a magnetic core, magnetic windings, and a cylindrical internal cavity. Said magnetic windings cause magnetic attraction between stator and rotor. The cavity of stator 1 is cylindrical, internally toothed, and concentric with output shaft 6. Rotor 2 is made from magnetically conductive materials, and is situated inside the stator. Rotor 2 is eccentric with output shaft 6, externally toothed and rotates with a high frequency oscillation but a low speed, around the inner diameter of stator 1. Rotor 2 has a few less teeth than stator 1. For example, rotor 2 may have 96 teeth and stator 1 may have 100 teeth. Rotor 2 is mounted on rotor bearings 4. Output carrier 3 is mounted on the output shaft. Carrier 3 is mounted on carrier bearings 5. Each of the carrier bearings 5 corresponds to one of the rotor bearings 4. Carrier bearings 5 and rotor bearings 4 are each mounted on an eccentric shaft such that the axis of each carrier bearing is constrained to describe a circular path about the axis of the corresponding rotor bearing. Thus the bearings act as transmission means by permitting the high frequency oscillation of the rotor and transmitting the slow rotation to the output shaft. The bearing means also act as constraining means by constraining the rotor to a fixed circular path and overcoming gear separation forces between gear teeth of the rotor and stator. Rotor 2 oscillates at high frequency yet rotates at low speed, with the difference between oscillation frequency and rotational speed being determined by the gear ratio between rotor and stator. The distance of the oscillation is small, so even with a high frequency oscillation, the speed and acceleration of the rotor remains low.

The eccentric bearing assembly forces the wobbler gear to follow the proper circular path and acts to resist the gear separation force.

The bearing arrangement (or constraining means comprising transmission means) of FIG. 3 is the preferred bearing arrangement but it will be readily appreciated that other bearing arrangements are possible to permit a high frequency oscillation and transmit a slow rotation.

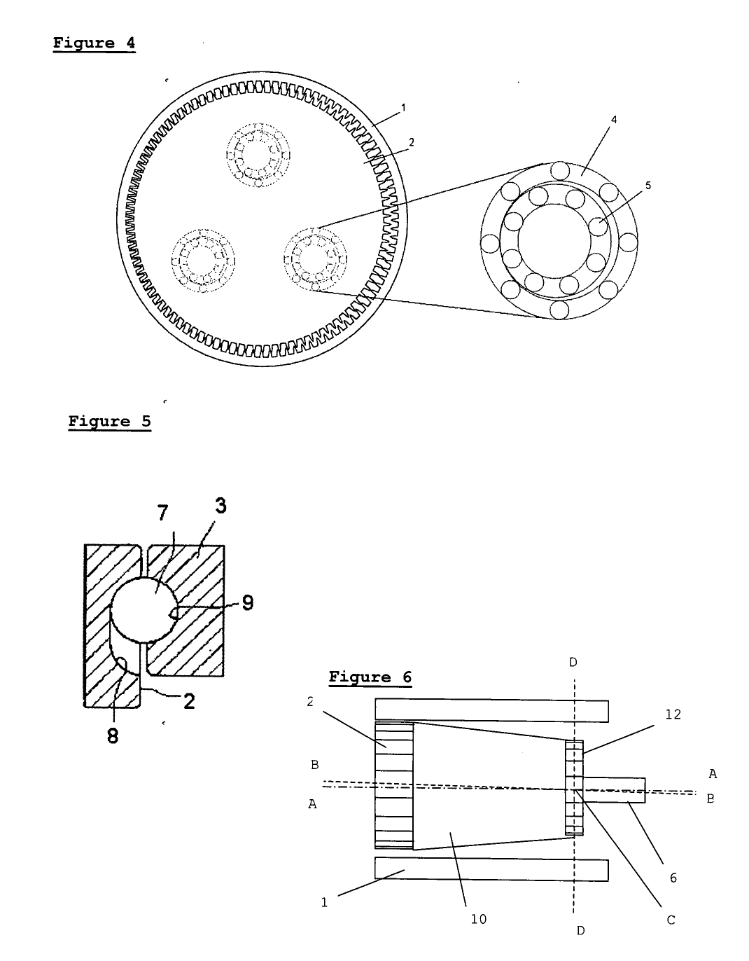

An alternative bearing arrangement is shown in FIG. 4. In this alternative, the corresponding pairs of rotor bearings 4 and carrier bearings 5 are mounted one inside the other, eccentric relative to each other. The eccentricity permits oscillation. Using more than one pair of bearings (for example three pairs, as in FIG. 3) maintains the relative angle between the rotor and the carrier and thus transmits the slow rotation.

In a further alternative bearing arrangement, bearings are manufactured with three races and two eccentric rings of balls.

In a further alternative bearing arrangement shown in FIG. 5, the rotor and carrier are mounted on one set of ball bearings 7, with the races 8 on the rotor side being oversized to permit oscillation and the races 9 on the carrier side being of usual size. An advantage of this arrangement is that the bearings are easy to manufacture. A disadvantage is that, since the bearings are not constrained to follow the edge of the oversized races, the system is less efficient. Other known bearing arrangements could also be used.

Means other than bearings may be used to permit high frequency oscillation and transmit slow rotation.

In one alternative, an Oldham Coupler or variation on such a coupler, or similar coupling arrangement may be used to permit oscillation and transmit rotation.

In a further alternative shown in FIG. 6, the geometrical axis of symmetry (B-B) of geared rotor 2 is oblique relative to an axis of symmetry (A-A) through the centre of the geared stator 1. (A-A is also the axis of rotation of the output shaft.) A casing 10 surrounds rotor 2. During operation, the rotor is submitted to a nutating motion (rocking in a circular path), such that the axis of symmetry (B-B) of the rotor moves as a generatrix along an imaginary cone, having apex (C) on the output shaft that is axially distanced from the rotor and stator. At the cone apex (C), the casing part 10 connected to rotor 2 is associated with a gear ring 12 which rotates in a plane (D-D) extending perpendicularly to said axis of symmetry. Gear ring 12 thus provides a slow rotation while permitting the high frequency oscillation.

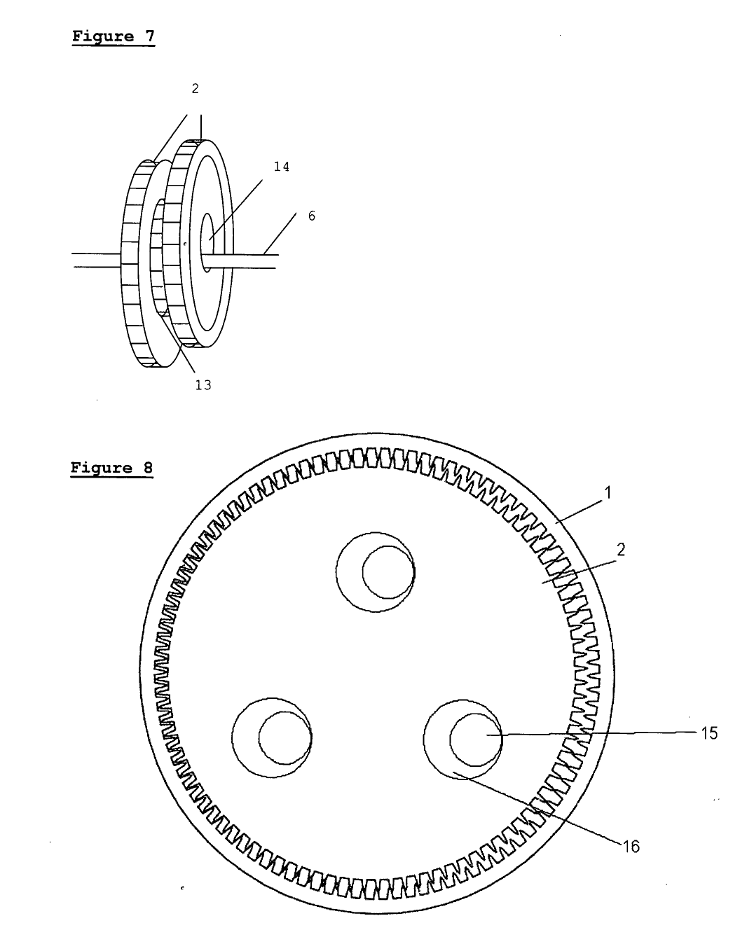

In a further alternative shown in FIG. 7, two magnetic, externally toothed rotors 2 rotate eccentrically inside a stator or stators (stators not drawn) and have holes 14 at their centre of greater radius than the output shaft to enable eccentric motion with respect to the output shaft. An output disc or output gear 13 is sandwiched between the two rotors 2 and coupled by eccentric bearings to each of the rotors 2. The rotors 2 are arranged such that the centre of gravity of the system is unchanging. The output gear 2 is rotatably, centrically mounted on the output shaft. Thus high frequency oscillation is permitted and only slow rotation transmitted.

In a further alternative shown in FIG. 8, oversized holes 16 are formed in the rotor 2, which holes rotate around pins 15 attached to an output gear. Pins 15 transmit rotation while holes 16 permit oscillation. An advantage of this arrangement is that the rotor can be decoupled from the output shaft using a clutch mechanism if desired. A disadvantage is that some magnetic force is used up in holding the rotor against the stator and is therefore not available for output torque generation.

In a further alternative, rheostatic fluids may be used as constraining and transmission means.

In further alternatives, springs, flexures, or tension elements, combined with a single centered offset bearing, are used. It will be readily understood that many configurations are possible to permit oscillation and transmit rotation, and this patent is not limited to those described herein.

Stator 1 may have any number of poles, and may be formed from any magnetic metal or other magnetic material. A characteristic of stator 1 is that is has internal gear teeth as well as magnetic windings. Various configurations are possible for the gear teeth of stator 1.

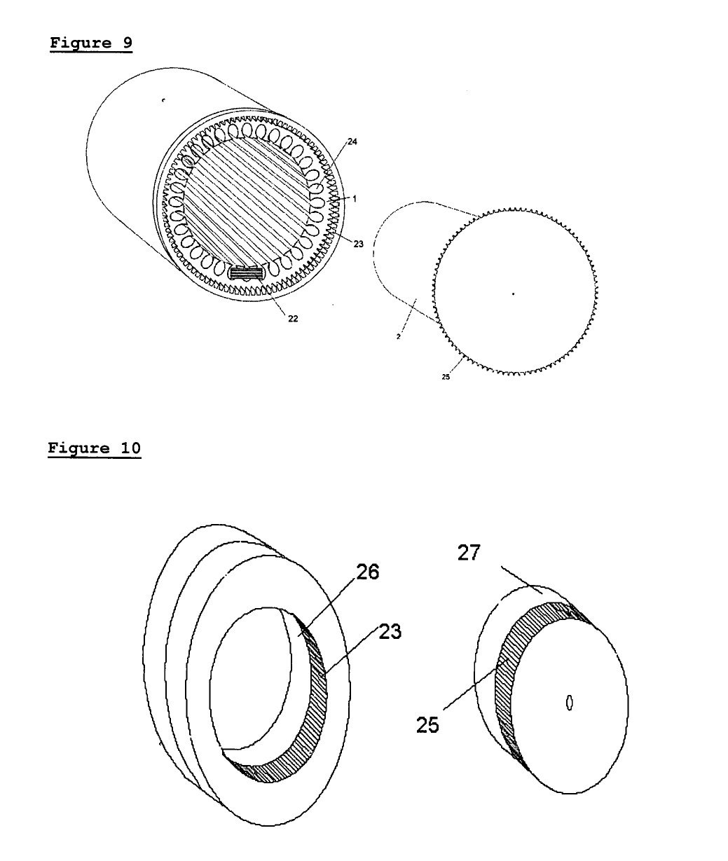

Preferably, said gear teeth of said stator are positioned an axial distance away from at least one edge of said stator, at a radius larger than the largest radius of the end turns of the windings, as shown in FIG. 9. Said gear teeth may also be positioned at an axial distance away from at least one edge of said stator at a radius smaller than the smallest radius of the end turns of the windings. Said gear teeth may or may not be of magnetic material. Stator 1 has slots 24 in which the windings are positioned. End turns 22 occupy space at the end of the stator. Only one end turn is shown, for diagrammatic clarity. Gear teeth 23 of the stator are positioned at the edge of the stator, at a greater radius than that of end turns 22, as shown. The rotor gear teeth 25 of the rotor 2 are positioned on at least one edge of said rotor, axially distanced from said the edge of said stator and corresponding to the gear teeth of said stator, and at a radius slightly smaller than the radius at which the stator gear teeth are placed. In this way, the teeth do not interfere with flux patterns.

Alternatively, the stator gear teeth may be formed into the face of the internal cavity of the stator (the geared surface thus being integral to the magnetic surface), and the rotor gear teeth positioned accordingly.

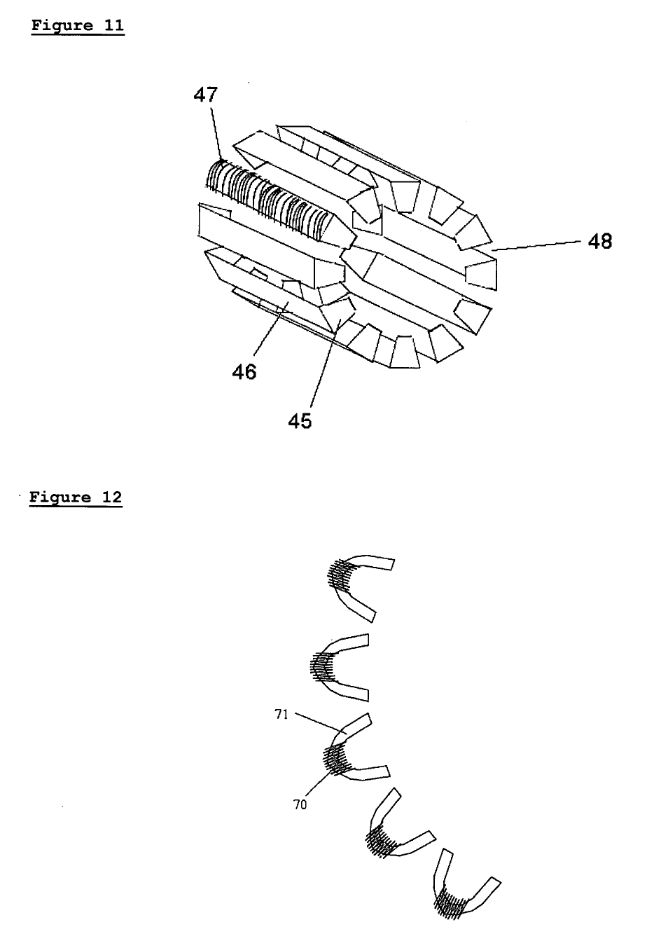

Alternatively, as shown in FIG. 10, the stator may comprise a layer of magnetic stator 26 and a layer of internally toothed stator 23, mechanically joined by any suitable joining means such as tongue and groove, adhesive, etc. The rotor may comprise a layer 27 of magnetic material and a layer 25 of externally toothed rotor, mechanically joined by any suitable joining means such as tongue and groove, adhesive, etc.

Alternatively, the stator may comprise several such layers of magnetic stator alternated with several such layers of internally toothed stator. The rotor may comprise several such layers of magnetic rotor alternated with several such layers of externally toothed rotor.

As a further alternative, said internal cavity of said stator may be of trapezoidal cross-section. Said rotor would therefore be of triangular cross section. An advantage of this is that, whereas with a cylindrical cross section, less than half of the winding interacts with the airgap, in this case almost ⅔ of the winding interacts with the airgap.

Several arrangements are possible for the magnetic windings. The windings may be arranged radially or tangentially.

Preferably, the magnetic windings are wound down one slot, across one end of the stator to the next.consecutive slot, up the next slot and back across the other end of the stator. Thus each winding surrounds one saliency between two consecutive slots, without one winding overlapping another. In other words, each winding has a span value of one. This reduces the amount of winding taken up as end turns, which do not provide flux. The saliencies may be of any size although saliencies covering a larger angle are preferred as this is a more flux-efficient arrangement.

The magnetic windings may also span more than one saliency between slots and may overlap each other. The magnetic windings may also be wound toroidaily, i.e. up through a slot of the stator and radially outwards at one end of the stator, down along the external circumference of the stator and radially inwards at the other end of the stator. This configuration requires shorter end turns and therefore fewer windings. Any other workable winding configuration may be used which will cause magnetic flux to pass in a closed loop between the stator and the rotor in such a way as to attract the rotor to the stator in a radial direction.

The magnetic windings may be wound around horseshoe stator saliencies as shown in FIG. 11. The stator is arranged with magnetically insulated poles having two saliencies 45, one at each end of the stator, joined by backiron 46. Windings 47 (only one shown for clarity) are wound around the backiron, and these horseshoe shaped sections are held together with non-magnetically conductive material 48. This is also known as transverse flux winding.

Furthermore buried horseshoe windings may be used, that is, horseshoe windings having saliencies along the circumference. This is equivalent to a toroidal winding where the stator is distorted to make more room for the coils, and is shown in FIG. 12, where windings 70 are wound around buried horseshoe saliencies 71. Other transverse flux arrangement possibilities include sharing flux between the legs of adjacent horseshoes, and horseshoes being arranged in transverse fashion rather than the circumferential horseshoes shown in FIG. 12.

As a further alternative, the transverse flux windings may be combined with permanent magnets, either on the rotor or the stator. In this arrangement, the permanent magnets tend to pull the rotor against the side of the system, providing the lateral holding necessary to hold the gears together. The electromagnets strengthen the magnetic field on one side of the contact patch between rotor and stator, and weaken it on the other side of said contact patch, providing rotational force to rotate the rotor.

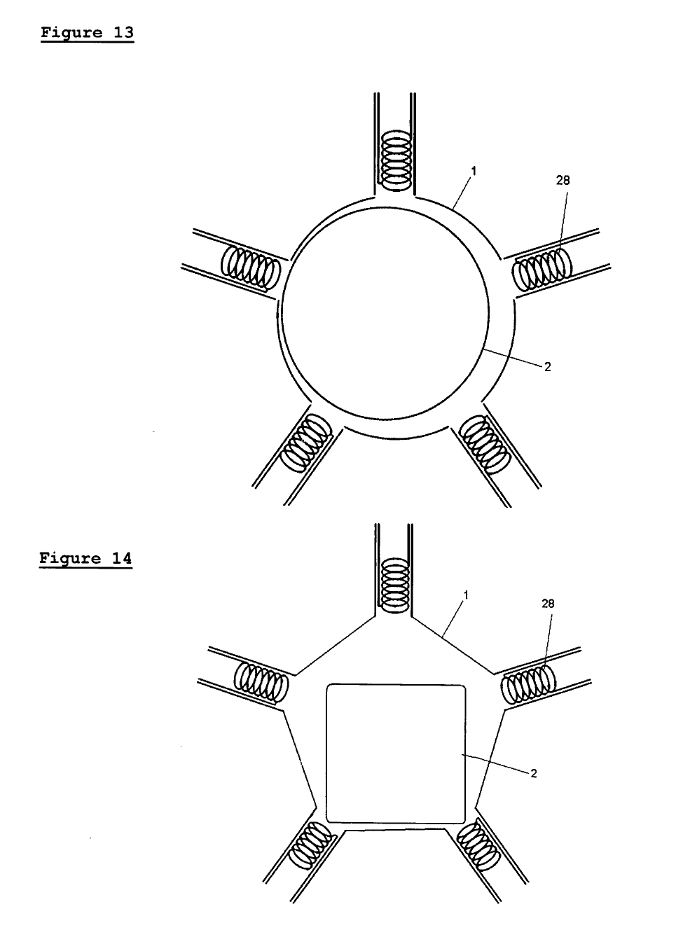

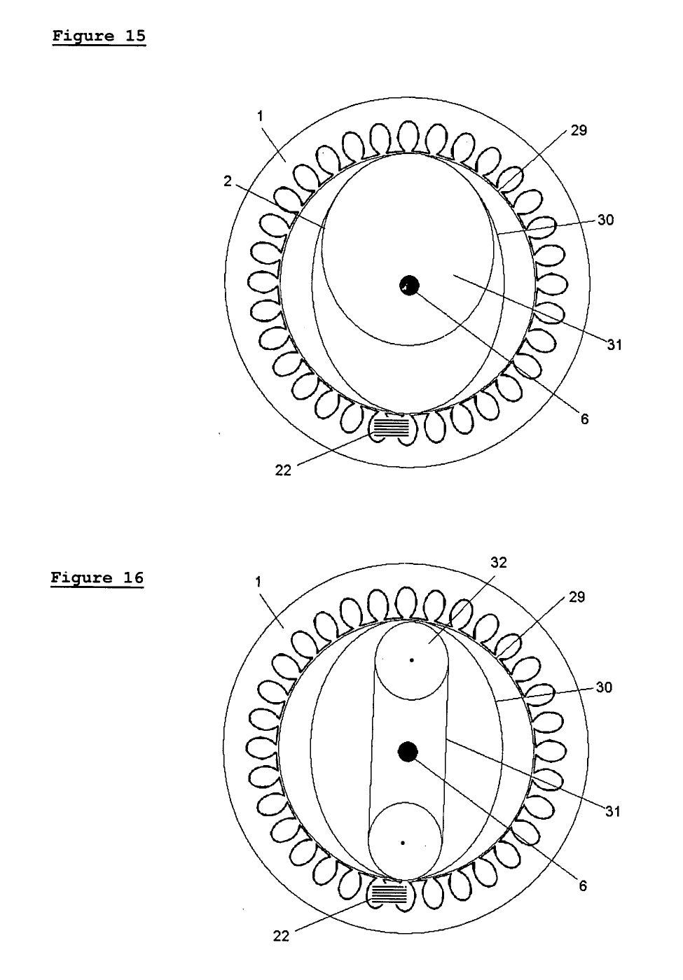

Furthermore, in place of conventional motor windings, radial solenoids may be used. As shown in FIG. 13, with this arrangement, at least two solenoids 28 are arranged radially around a stator 1. The more solenoids are present, the smoother the motion will be. Solenoids 28 are energized periodically such that rotor 2 is attracted to each solenoid in turn around stator 1 and therefore travels around the internal cavity of stator 1. The internal cavity of stator 1 and the external surface of rotor 2 may be smooth or may have gear teeth, stator 1 having a few, e.g. 5, more teeth than rotor 2. If the internal cavity of stator 1 and the external surface of rotor 2 are smooth, the rotor will slip around the stator in a circular motion. If the internal cavity of stator 1 and the external surface of rotor 2 are toothed, the rotor will oscillate eccentrically at high frequency around the axis of the stator with a superimposed slow rotation. With this configuration, high torques can be sustained. Further, a radial solenoid configuration may have a fixed and driven member of non-circular cross-sections in place of a stator and rotor. Said fixed and driven members may be polygonal with the driven member having fewer sides than the fixed member (shown in FIG. 14 where stator 1 is pentagonal in cross-section and rotor 2 is square in cross-section, having five solenoids 28), or said fixed member may be linear with said driven member oscillating between ends of said fixed member, or any other workable shapes of fixed and driven members.

A specific example of the numbers of teeth of the stator and eccentric geared rotor will now be given, without limitation. In the eccentric system, the contact patch between the rotor and stator moves at high speed. The rotor is essentially be wobbling back at forth at the same frequency, but no part of the system is actually rotating at high speed. An internally toothed stator may be 13″ in diameter with 320 teeth, and an externally toothed rotor may be 12.5″ in diameter with 308 teeth. Although this cannot be described in terms of regular gear ratios, since the contact patch rotates 27 times for each rotation of the rotor, this can be termed a 27:1 ‘eccentric gear ratio’. Here, instead of rotating 27 times, the rotor has wobbled back and forth by ½″ 27 times each time it rotates once.

The following is an analysis of the available attractive force and in terms of the gear teeth of the above specific example.

The gears may be 3″ thick, of which 2.25″ can be counted as being part of the magnetic circuit. Attractive force can only be applied when the two gears are within 0.1″ apart. Approximately ¼ of the entire circumference of the stator is available for attraction. However, to achieve motion, a trailing portion of the stator must be demagnetized while a leading portion is magnetized. Therefore, only approximately ⅛ of the circumference is available for active application of the magnetic field. Thus there is a region of approximately 2.25″×5″ in which magnetic force can be applied, at a pressure of 150 PSI. This produces 1700 pounds of attractive force, using normal materials, without overstressing the magnetic materials. Using suitable high saturation density materials such as hiperco alloys, flux densities in excess of 2.2T may be achieved, resulting in attractive pressure in excess of 250 PSI.

In a second embodiment of the invention, shown in FIG. 15, a motor comprises a stator 1 having a magnetic core, magnetic windings 22 (only one shown for clarity), and a cylindrical internal cavity; an eccentric rotor 2 eccentrically mounted inside the stator; and a flexible spline 30 (as known in the field of harmonic gearing), concentrically mounted inside the stator and coupled both to the rotor and to an output shaft 6. The motor is mounted on a bearing and can rotate.

During operation, the stator is magnetized in such a way that the rotor is pulled around the internal cavity of the stator, eccentrically oscillating at high frequency and rotating. Since the rotor is coupled to the spline, the spline rotates with the rotor but flexes to accommodate the eccentric oscillation of the rotor, thus only the rotation is transmitted by the spline to the output shaft. An advantage of this arrangement is that the motor can be integrally combined with the gearing.

Preferably, the internal surface of the stator is toothed. Preferably, the flexible spline is externally toothed and is made from flexible, non-magnetic material, for example but without limitation, spring temper steel. Alternatively, the spline gear teeth may be made from individual pieces of rigid metal such as hardened steel which are attached, for example by welding, to the flexible spline but do not themselves form a solid ring. The spline has a few less gear teeth than the stator.

Alternatively, the motor is arranged as shown in FIG. 16. The motor comprises a stator 1 having a magnetic core, magnetic windings 22 (only one shown for clarity), and a cylindrical internal cavity; a stator 2 eccentrically mounted inside the stator; and a flexible spline 30, concentrically mounted inside the stator and coupled to an output shaft 6. A wave generator 31 is rotatably mounted on the output shaft 6, and positioned inside the flexible spline 30. The wave generator is a linear shaft having a roller 32 made of magnetic material, at each end. The rollers force the flexible spline into contact with the internal surface 29 of the stator at two opposite points, that is, two points 180 degrees apart. The outer surface of the spline 30 and the inner surface 29 of the stator have gear teeth so that the spline engages the stator in two locations, 180 degrees apart. The stator has a few, e.g. 5, less gear teeth than the stator. During operation, pairs of opposite sections of the stator 1 are magnetized together, in a periodic cycle. For example, in a twelve-pole stator, the windings at 0 and 180 degrees are magnetized, then the windings at 30 and 210 degrees, then the windings at 60 and 240 degrees, then the windings at 90 and 270 degrees, etc. The wave generator is pulled around by this moving magnetic field and, as the rollers roll without slipping along the inside surface of the flexible spline, the two contact points between the spline and the stator rotate with the wave generator. Thus the spline is continually distorted by the rotating, high-frequency wave generator, but the overall rotation of the spline itself is slow. The rotation of the spline is coupled to the output shaft, thus only the slow rotation of the spline is transmitted to the output shaft. An advantage of this arrangement is that the spline is distorted by the wave generator and no magnetic force is lost in distorting the spline. A further advantage is that the spline is oscillating at high speed without rotating at high speed.

Alternatively there is no wave generator and the spline is made from magnetic material. The internal surface of the stator and the external surface of the spline are toothed and engage each other. The spline has a few less teeth than the stator. During operation, pairs of opposite sections of the stator 1 are magnetised together, in a periodic cycle. For example, in a twelve-pole stator, the windings at 0 and 180 degrees are magnetised, then the windings at 30 and 210 degrees, then the windings at 60 and 240 degrees, then the windings at 90 and 270 degrees, etc. The spline is distorted by this magnetic field into contact with the stator at two points, 180 degrees apart. The rotation of the field causes the spline to rotate with the field. The external teeth of the spline engage the internal teeth of the stator, thus the spline oscillates at high frequency with the rotation of the field, and rotates slowly due to the small difference in number of teeth. The spline is coupled to the output shaft, thus only the slow rotation of the spline is transmitted to the output shaft. An advantage of this arrangement over the wave generator arrangement is that there are no parts rotating at high speed. A disadvantage is that some magnetic force is used up in distorting the spline and is therefore not available for output torque generation. However, because the spline is a spring, magnetic energy used to distort the spline may be recovered as electrical energy regenerated as the spline relaxes.

Stator 1 may have any number of windings, and may be formed from any magnetic metal or other magnetic material. In the case where stator 1 has internal gear teeth as well as magnetic windings, various configurations are possible for the gear teeth of stator 1.

Preferably, said gear teeth of said stator are positioned axially distanced from at least one edge of said stator, at a radius larger than the largest radius of the end turns of the windings, as shown in FIG. 9. Stator 1 has slots 24 in which the windings are positioned. End turns 22 occupy space at the end of the stator. Only one end turn is shown, for diagrammatic clarity. Gear teeth 23 of the stator are positioned at the edge of the stator, axially distanced from the end turns of said stator, at a greater radius than that of end turns 22, as shown. For a flexible spline having gear teeth, the spline gear teeth are positioned on at least one edge of said spline, corresponding to the gear teeth of said stator. The spline gear teeth are mounted flexibly on the flexible spline such that when the spline flexes, the gear teeth flex in the same shape as the spline. The gear teeth are made from a flexible material such as a spring temper. With this arrangement, the teeth do not interfere with flux patterns.

Alternatively, the stator gear teeth may be formed into the face of the internal cavity of the stator and the spline rotor gear teeth positioned correspondingly.

In the case of an eccentric rotor coupled to a spline, the rotor may be coupled to the spline by being mounted inside the spline, such that magnetic forces pull the rotor around, the rotor pushes the spline teeth against the stator teeth and the spline engages the stator and rotates against it. In this arrangement, magnetic material is incorporated into the spline. Alternatively, the rotor may be toothed and engage the internally toothed stator directly, and protrude from the internal cavity of the stator. The protruding portion of the rotor may then be coupled to the internal teeth of the spline.

Several arrangements are possible for the magnetic windings. The windings may be arranged radially or tangentially.

Preferably, the magnetic windings are wound down one slot, across one end of the stator to the next consecutive slot, up the next slot and back across the other end of the stator. Thus each winding surrounds one saliency between two consecutive slots, without one winding overlapping another. In other words, each winding has a span value of one. This reduces the amount of winding taken up as end turns, which do not provide flux. The saliencies may be of any size although saliencies covering a larger angle are preferred as this is a more flux-efficient arrangement.

The magnetic windings may also span more than one saliency between slots and may overlap each other. The magnetic windings may also be wound toroidally, i.e. up through a slot of the stator and radially outwards at one end of the stator, down along the external circumference of the stator and radially inwards at the other end of the stator. This configuration requires shorter end turns and therefore fewer windings. Any other workable winding configuration may be used which will cause magnetic flux to pass in a closed loop between the stator and the rotor in such a way as to attract the rotor to the stator in a radial direction.

The magnetic windings may be wound around horseshoe stator saliencies as shown in FIG. 11. This is known in the art as a transverse flux geometry. The stator is arranged with magnetically insulated poles having two saliencies 45, one at each end of the stator, joined by backiron 46. Windings 47 (only one shown for clarity) are wound around the backiron, and these horseshoe shaped sections are held together with non-magnetically conductive material 48.

Furthermore, in place of conventional motor windings, radial solenoids may be used. As shown in FIG. 13, with this arrangement, at least two solenoids 28 are arranged radially around a stator 1. The more solenoids are present, the smoother the motion will be. Solenoids 28 are energized periodically such that the rotor is attracted to each solenoid in turn around stator 1 and therefore travels around the internal cavity of stator 1.

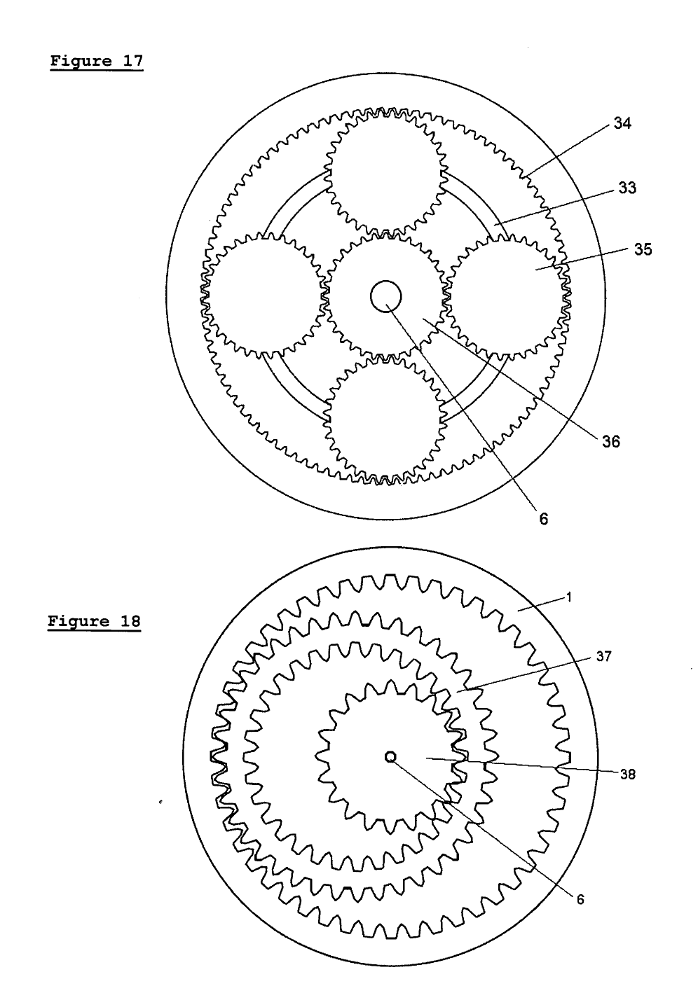

In a third embodiment of the invention, a motor is disclosed, comprising a stator having a magnetic core, magnetic windings, and a cylindrical internal cavity; and at least two planetary gear rotors made from magnetically conductive materials, situated inside the stator. The third embodiment is shown in FIG. 17. The sun gear 36 is centrically mounted on the output shaft 6. At least two planetary gear rotors 35 rotate around the sun gear 36. The planet gears rotors 35 are mounted on a planet carrier 33 which is concentric with the output shaft. The planet gear rotors 35 mesh with the internal, toothed cavity 34 of the stator. Magnetic normal force is induced around the circumference of the stator, at different angular positions of the stator corresponding to just in front of each planet gear rotor, such that each planet gear rotor is pulled around the stator, such that the contact patches between the planets and the stator move in circular periodic motion around the inner circumference of the stator. For example, for a twelve-pole stator, the poles at 0, 90, 180 and 270 degrees would be magnetized, then those at 30, 120, 210 and 300 degrees, etc. The planet gear rotors cause the sun gear to rotate which in turn rotates the output shaft. Planetary gear ratio theory can be used to determine the speed of the output with respect to the input.

Stator 1 may have any number of poles, and may be formed from any magnetic metal or other magnetic material. A characteristic of stator 1 is that is has internal gear teeth as well as magnetic windings. Various configurations are possible for the gear teeth and magnetic windings of stator 1.

Preferably, said gear teeth of said stator are positioned on at least one edge of said stator, at a radius larger than the largest radius of the end turns of the windings, as shown in FIG. 9. Stator 1 has slots 24 in which the windings are positioned. End turns 22 occupy space at the end of the stator. Only one end turn is shown, for diagrammatic clarity. Gear teeth 23 of the stator are positioned at the edge of the stator, at a greater radius than that of end turns 22, as shown. The planet and sun gear teeth are positioned on at least one edge of said motor, corresponding to the position of the stator gear teeth. In this way, the teeth do not interfere with flux patterns.

Alternatively, the stator gear teeth may be formed into the face of the internal cavity of the stator and the sun and planet gear teeth sized accordingly.

Alternatively, the stator may comprise a layer of magnetic stator 26 and a layer of internally toothed stator 23, mechanically joined by any suitable joining means such as tongue and groove, adhesive, etc. Such a stator is shown in FIG. 10. The planet gear rotors may each comprise a layer of magnetic stator and a layer of externally toothed rotor, mechanically joined by any suitable joining means such as tongue and groove, adhesive, etc. Thus the planet gear rotors are pulled around by the magnetic layer and engage the sun gear with the toothed layer. The gear teeth between the stator and the planet gear rotors ensure that high torque can be sustained in the motor. The sun gear does not require a magnetic layer.

Alternatively, the stator may comprise several such layers of magnetic stator alternated with several such layers of internally toothed stator. The rotors may comprise several such layers of magnetic rotor alternated with several such layers of externally toothed rotor. The sun gear may comprise several layers of toothed gear on an output shaft, alternated with empty space, or one long toothed gear, or any workable configuration.

Several arrangements are possible for the magnetic windings. The windings may be arranged radially or tangentially.

Preferably, the magnetic windings are wound down one slot, across one end of the stator to the next consecutive slot, up the next slot and back across the other end of the stator. Thus each winding surrounds one saliency between two consecutive slots, without one winding overlapping another. In other words, each winding has a span value of one. This reduces the amount of winding taken up as end turns, which do not provide flux. The saliencies may be of any size although saliencies covering a larger angle are preferred as this is a more flux-efficient arrangement.

The magnetic windings may also span more than one saliency between slots and may overlap each other. The magnetic windings may also be wound toroidally, i.e. up through a slot of the stator and radially outwards at one end of the stator, down along the external circumference of the stator and radially inwards at the other end of the stator. This configuration requires shorter end turns and therefore fewer windings. Any other workable winding configuration may be used which will cause magnetic flux to pass in a closed loop between the stator and the rotor in such a way as to attract the rotor to the stator in a radial direction.

The magnetic windings may be wound around horseshoe stator saliencies as shown in FIG. 11. The stator is arranged with magnetically insulated poles having two saliencies 45, one at each end of the stator, joined by backiron 46. Windings 47 (only one shown for clarity) are wound around the backiron, and these horseshoe shaped sections are held together with non-magnetically conductive material 48.

Furthermore, in place of conventional motor windings, radial solenoids may be used. As shown in FIG. 13, with this arrangement, at least two solenoids 28 are arranged radially around a stator 1. The more solenoids are present, the smoother the motion will be. Solenoids 28 are energized periodically such that the rotor is attracted to each solenoid in turn around stator 1 and therefore travels around the internal cavity of stator 1.

In a fourth embodiment of the invention, shown in FIG. 18, a motor is disclosed, comprising a stator 1 having a magnetic core, magnetic windings, and a cylindrical internal cavity; and an eccentric ring gear rotor 37 made from magnetically attractive materials, situated inside the stator. The eccentric ring gear rotor has an outer diameter significantly smaller than the inner diameter of the stator and is internally and externally toothed. A smaller gear 38 is situated inside the ring gear rotor, concentric with the stator, mounted on the output shaft. The outer diameter of the smaller concentric gear 38 and the inner diameter of the stator 1 have gear teeth. The eccentric ring gear rotor 37 engages the stator on its outside and the smaller concentric gear on its inside. Thus the eccentric ring gear rotor connects the smaller concentric gear to the stator. In general, the gears are very similar in size, with the concentric gear 38 not much smaller than the innder diameter of the stator 1, and the ring gear rotor 37 as thin as possible while remaining stiff.

Magnetic normal force is induced around the circumference of the stator, at different angular positions of the stator periodically, such that the eccentric ring gear rotor is periodically attracted to different regions around the stator, such that the contact patch between the ring gear rotor and the stator moves in circular periodic motion around the inner circumference of the stator. The ring gear rotor engages the smaller concentric gear, oscillating around it such that the contact patch between the ring gear rotor and the smaller concentric gear moves in circular periodic motion around the smaller concentric gear. The rotor oscillates with high frequency and slowly rotates. Only the slow rotation is transmitted to the smaller concentric gear, which drives the output shaft. An advantage of this design is that it ensures minimal gear tooth wear since at any one time the load is spread over many gear teeth compared with, for example, an planetary gear arrangement. A further advantage is that arrangement can be made for decoupling the stator from the concentric gear by moving the ring gear rotor concentric with the output shaft, for example for high speed operation.

Stator 1 may have any number of poles, and may be formed from any magnetic metal or other magnetic material. A characteristic of stator 1 is that is has internal gear teeth as well as magnetic windings. Various configurations are possible for the gear teeth and magnetic windings of stator 1.

Preferably, said gear teeth of said stator are positioned on at least one edge of said stator, at a radius larger than the largest radius of the end turns of the windings. Stator 1 has slots 24 in which the windings are positioned. End turns 22 occupy space at the end of the stator. Only one end turn is shown, for diagrammatic clarity. Gear teeth 23 of the stator are positioned at the edge of the stator, at a greater radius than that of end turns 22, as shown. This is shown in FIG. 9. The external gear teeth of the eccentric ring gear rotor are positioned on at least one edge of said ring gear rotor, corresponding to the gear teeth of said stator, and at a radius slightly smaller than the radius at which the stator gear teeth are placed. Thus the external gear teeth of the ring gear rotor extend radially outwards from the magnetic body of the ring gear rotor. The internal gear teeth of the ring gear rotor and the gear teeth of the concentric gear are sized accordingly. In this way, the teeth do not interfere with flux patterns.

Alternatively, the stator gear teeth may be formed into the face of the internal cavity of the stator. In this case, the ring gear rotor gear teeth need not extend radially outwards from the magnetic body of the ring gear rotor.

Alternatively, the stator may comprise a layer of magnetic stator 26 and a layer of internally toothed stator 23, mechanically joined by any suitable joining means such as tongue and groove, adhesive, etc. This is shown in FIG. 10. The ring gear rotor may comprise a layer of magnetic stator and a layer of externally toothed rotor, mechanically joined by any suitable joining means such as tongue and groove, adhesive, etc. The concentric gear may be one cylindrical gear as long as the ring gear rotor, with teeth extending along its whole length, or with teeth extending along only the length corresponding to the ring gear rotor teeth, or the concentric gear may extend only to the length corresponding to the ring gear rotor teeth, or any other workable arrangement.

Alternatively, the stator may comprise several such layers of magnetic stator alternated with several such layers of internally toothed stator. The ring gear rotor may comprise several such layers of magnetic rotor alternated with several such layers of externally toothed rotor. The concentric gear may be one cylindrical gear as long as the ring gear rotor, with teeth extending along its whole length, or with teeth extending along only the length corresponding to the ring gear rotor teeth, or the concentric gear may extend only to the length corresponding to the ring gear rotor teeth, or any other workable arrangement.

Several arrangements are possible for the magnetic windings. The windings may be arranged radially or tangentially.

Preferably, the magnetic windings are wound down one slot, across one end of the stator to the next consecutive slot, up the next slot and back across the other end of the stator. Thus each winding surrounds one saliency between two consecutive slots, without one winding overlapping another. In other words, each winding has a span value of one. This reduces the amount of winding taken up as end turns, which do not provide flux. The saliencies may be of any size although saliencies covering a larger angle are preferred as this is a more flux-efficient arrangement.

The magnetic windings may also span more than one saliency between slots and may overlap each other. The magnetic windings may also be wound toroidally, i.e. up through a slot of the stator and radially outwards at one end of the stator, down along the external circumference of the stator and radially inwards at the other end of the stator. This configuration requires shorter end turns and therefore fewer windings. Any other workable winding configuration may be used which will cause magnetic flux to pass in a closed loop between the stator and the rotor in such a way as to attract the rotor to the stator in a radial direction.

The magnetic windings may be wound around horseshoe stator saliencies as shown in FIG. 11. The stator is arranged with magnetically insulated poles having two saliencies 45, one at each end of the stator, joined by backiron 46. Windings 47 (only one shown for clarity) are wound around the backiron, and these horseshoe shaped sections are held together with non-magnetically conductive material 48.

Furthermore, in place of conventional motor windings, radial solenoids may be used. As shown in FIG. 13, with this arrangement, at least two solenoids 28 are arranged radially around a stator 1. The more solenoids are present, the smoother the motion will be. Solenoids 28 are energized periodically such that the ring gear rotor is attracted to each solenoid in turn around stator 1 and therefore travels around the internal cavity of stator 1.

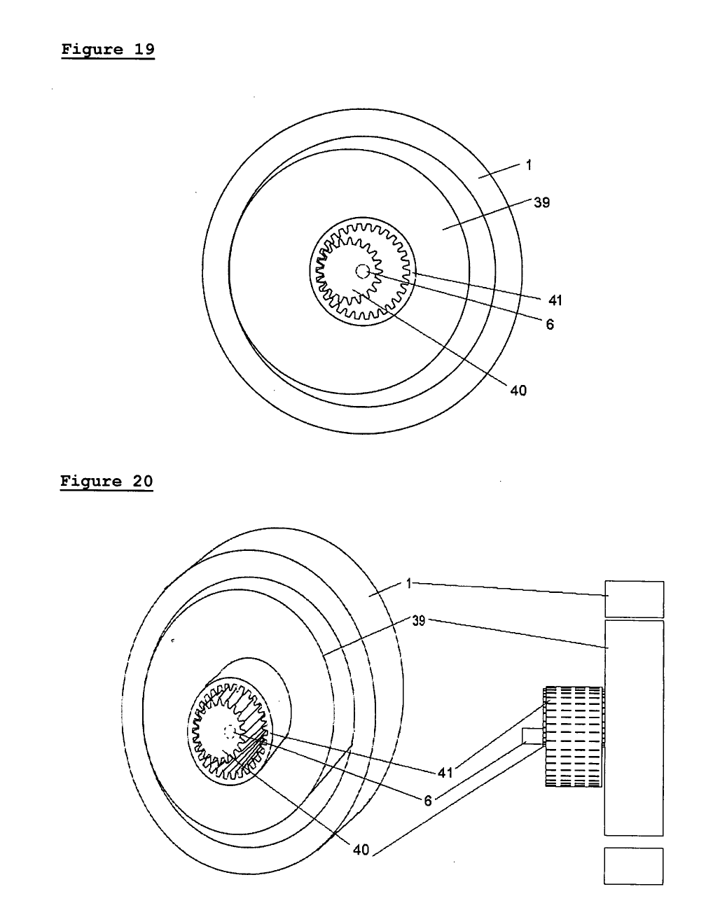

In a fifth embodiment of the invention, shown in FIG. 19, a motor is disclosed, comprising a stator 1 having a magnetic core, magnetic windings, and a cylindrical internal cavity; and a rotor 39 made from magnetically attractive materials, situated inside the stator. The rotor has an outer diameter significantly smaller than the inner diameter of the stator and is eccentric with respect to the stator. The outer diameter of the rotor and the inner diameter of the stator are smooth magnetic surfaces. A small, externally toothed gear 40 is non-rotationally mounted on the rotor 39, concentric with the rotor. The rotor gear 40 engages the inner surface of an internally toothed output gear 41, concentric with the stator, mounted on the output shaft 6. Magnetic normal force is induced around the circumference of the stator, at different angular positions of the stator periodically, such that the rotor 39 is periodically attracted to different regions around the stator, such that the contact patch between the rotor and the stator moves in oscillating periodic motion around the inner circumference of the stator, with a superimposed slow rotation. Rotor gear 40 moves with rotor 39 and therefore describes a circle rotating around the inner surface of output gear 41, with a superimposed slow rotation. Output gear 41 is rotationally, centrically mounted on the output shaft 6 and therefore transmits the slow rotation without the oscillation.

Note that in FIG. 19 the output gear is concentric with the stator, driving the output shaft. The rotor gear is concentric with the rotor. The rotor and its gear are eccentric with respect to the stator and output shaft.

Stator 1 may have any number of poles, and may be formed from any magnetic metal or other magnetic material.

Various configurations are possible for the gear teeth of the fifth embodiment.

A preferred arrangement for the gear teeth of the fifth embodiment is shown in FIG. 20. The rotor gear 40 and output gear 41 protrude from the plane of the rotor 39 and stator 1. Thus the magnetic components are in a separate layer from the gear components. The output shaft 6 penetrates through all components. The rotor 39 has an oversized hole at its centre and may have bearings, to accommodate the eccentric oscillation about the output shaft 6.

Alternatively, there may be more than one layer of the magnetic (rotor-stator) plane and/or more than one layer of the gear plane. This would add rigidity and ruggedness to the motor. The layers may be mechanically joined by any suitable joining means such as tongue and groove, adhesive, etc.

Several arrangements are possible for the magnetic windings in the stator. The windings may be arranged radially or tangentially.

Preferably, the magnetic windings are wound down one slot, across one end of the stator to the next consecutive slot, up the next slot and back across the other end of the stator. Thus each winding surrounds one saliency between two consecutive slots, without one winding overlapping another. In other words, each winding has a span value of one. This reduces the amount of winding taken up as end turns, which do not provide flux. The saliencies may be of any size although saliencies covering a larger angle are preferred as this is a more flux-efficient arrangement.

The magnetic windings may also span more than one saliency between slots and may overlap each other. The magnetic windings may also be wound toroidally, i.e. up through a slot of the stator and radially outwards at one end of the stator, down along the external circumference of the stator and radially inwards at the other end of the stator. This configuration requires shorter end turns and therefore fewer windings. Any other workable winding configuration may be used which will cause magnetic flux to pass in a closed loop between the stator and the rotor in such a way as to attract the rotor to the stator in a radial direction.

The magnetic windings may be wound around horseshoe stator saliencies as shown in FIG. 11. The stator is arranged with magnetically insulated poles having two saliencies 45, one at each end of the stator, joined by backiron 46. Windings 47 (only one shown for clarity) are wound around the backiron, and these horseshoe shaped sections are held together with non-magnetically conductive material 48.

Furthermore, in place of conventional motor windings, radial solenoids may be used. As shown in FIG. 13, with this arrangement, at least two solenoids 28 are arranged radially around a stator 1. The more solenoids are present, the smoother the motion will be. Solenoids 28 are energized periodically such that the rotor is attracted to each solenoid in turn around stator 1 and therefore travels around the internal cavity of stator 1.

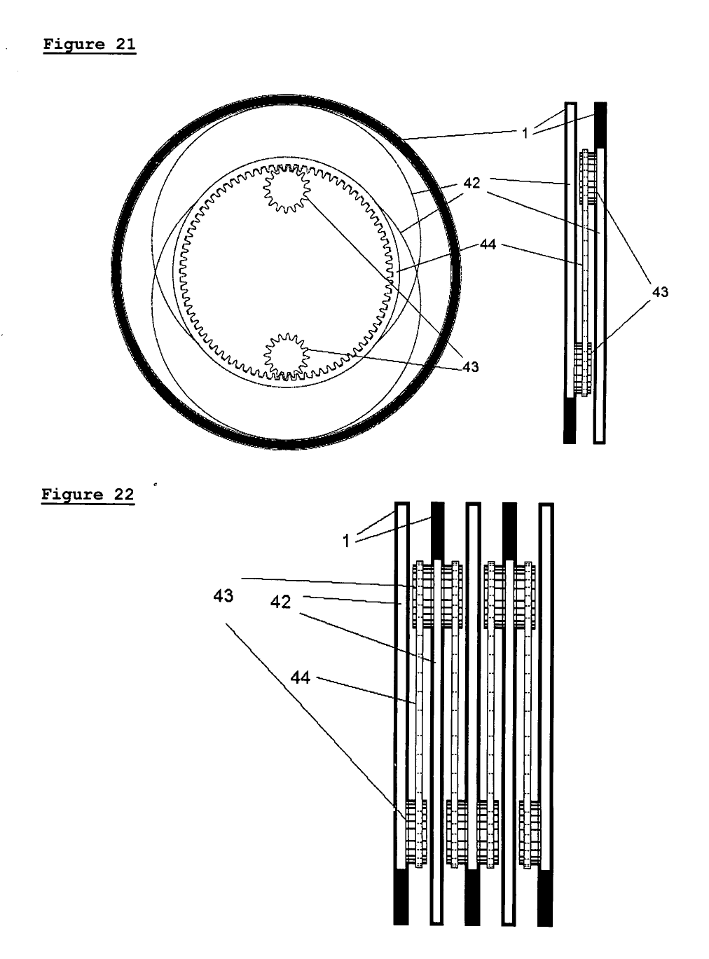

In a sixth embodiment of the invention, shown in FIG. 21, a motor is disclosed, comprising two stators 1, each having a magnetic core, magnetic windings, and a cylindrical internal cavity; and two rotors 42 made from magnetically attractive materials, situated one inside each stator. Each rotor has an outer diameter significantly smaller than the inner diameter of the stators. One rotor is eccentrically mounted inside each stator. An externally toothed gear 42 is non-rotatably mounted on each rotor 42. The externally toothed gears 42 engage the inside of an internally toothed larger gear 44 which is rotatably, concentrically mounted on the output shaft, so that the gear 43 is concentric with the stators 1. During operation, magnetic normal force is induced around the circumference of each stator, at different angular positions of the stator periodically, such that the rotors are periodically attracted to different regions around the stator, such that the contact patches between the rotors and the stators move in circular periodic motion around the inner circumferences of the stators. The magnetic force in one stator is maintained 180 degrees out of phase with that in the other stator, such that the two rotors occupy opposite (180 degrees apart) locations on their respective stators at any instant. The rotors oscillate with high frequency around the insides of the stators with a superimposed slow overall rotation. The two small gears 43 protrude from each rotor and are situated in a layer between the two rotors. The gears 43 rotate eccentrically with their respective rotors and engage opposite (180 degrees apart) locations on the output gear 44. As the rotors oscillate and rotate, the small gears 43 oscillate about the inside of the large gear 44 at the frequency of the oscillation of the rotor, and rotate slowly at the frequency of the slow rotation of the rotors. The large gear 44 is rotationally concentrically mounted on an output shaft and therefore rotates at the speed of the slow rotation of the rotors. Thus the slow overall rotation of the rotors is transmitted to the output shaft.

The rotors 42 have oversized holes at their centers and may have bearings, to accommodate their eccentric oscillation about the output shaft 6.

An advantage of this embodiment compared with the first embodiment is that forces are balanced over the whole motor. A further advantage is that the geared layer magnetically insulates the two magnetic layers from each other, preventing either magnetic layer from interfering with the flux pattern of the other.

Preferably, there are two magnetic layers and one gear layer. Each rotor and corresponding stator is one magnetic layer, and the two rotor gears and the output gear form the geared layer. The geared layer magnetically insulates the two magnetic layers from each other.

Alternatively, there may be more than two magnetic layers and/or more than one geared layer. This would add rigidity and ruggedness to the motor. It is preferable to have an even number of magnetic layers, to balance the forces in the motor. It is also preferable for the number of geared layers to be equal to one less than the number of magnetic layers, with magnetic layers on each outside end. It is further preferable for the layers to be arranged alternately, i.e. magnetic layer, geared layer, magnetic layer, geared layer, magnetic layer etc. An example is shown in FIG. 22.

For all arrangements, the layers may be mechanically joined by any suitable joining means such as tongue and groove, adhesive, etc.

Several arrangements are possible for the magnetic windings in the stators. The windings may be arranged radially or tangentially.

Preferably, the magnetic windings are wound down one slot, across one end of the stator to the next consecutive slot, up the next slot and back across the other end of the stator. Thus each winding surrounds one saliency between two consecutive slots, without one winding overlapping another. In other words, each winding has a span value of one. This reduces the amount of winding taken up as end turns, which do not provide flux. The saliencies may be of any size although saliencies covering a larger angle are preferred as this is a more flux-efficient arrangement.

The magnetic windings may also span more than one saliency between slots and may overlap each other. The magnetic windings may also be wound toroidally, i.e. up through a slot of the stator and radially outwards at one end of the stator, down along the external circumference of the stator and radially inwards at the other end of the stator. This configuration requires shorter end turns and therefore fewer windings. Any other workable winding configuration may be used which will cause magnetic flux to pass in a closed loop between the stator and the rotor in such a way as to attract the rotor to the stator in a radial direction.

The magnetic windings may be wound around horseshoe stator saliencies as shown in FIG. 11. The stator is arranged with magnetically insulated poles having two saliencies 45, one at each end of the stator, joined by backiron 46. Windings 47 (only one shown for clarity) are wound around the backiron, and these horseshoe shaped sections are held together with non-magnetically conductive material 48.

Furthermore, in place of conventional motor windings, radial solenoids may be used. As shown in FIG. 13, with this arrangement, at least two solenoids 28 are arranged radially around a stator 1. The more solenoids are present, the smoother the motion will be. Solenoids 28 are energized periodically such that the rotor is attracted to each solenoid in turn around stator 1 and therefore travels around the internal cavity of stator 1.

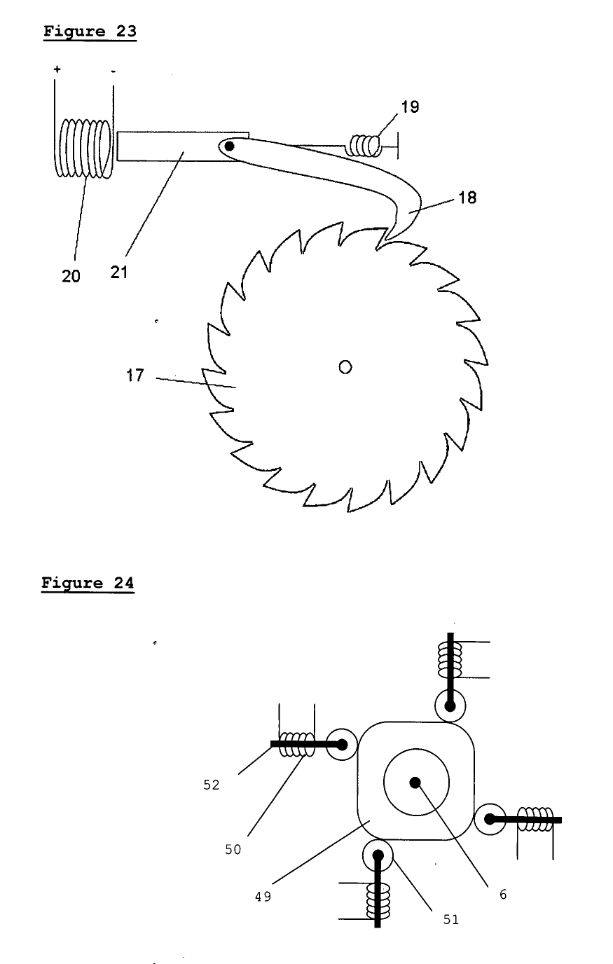

In a seventh embodiment of the invention, a ratchet and pawl mechanism is used, as shown in FIG. 23. The fixed member of the invention is magnetic coil 20, and the driven member is arm 21. When coil 20 is magnetized, arm 21, which may be made from any hard or soft magnetic material, is attracted by and pulled towards the coil. Pawl 18 is pivotally attached to arm 21 and is therefore also pulled towards the coil. The pawl engages a tooth of ratchet 17 and thus, when the arm is pulled towards the coil, the ratchet turns by one tooth (shown anticlockwise in FIG. 23 although this is not limiting). When coil 20 is demagnetized, spring 19 pulls on arm 21. Arm 21 then pushes pawl 18, which slides over the long side of the next tooth, ready for the next pulling operation. During operation, coil 20 is periodically and rapidly magnetized and demagnetized. Thus reciprocal motion in arm 21 is converted to rotational motion in ratchet 17. Ratchet 17 is connected to the output shaft of the motor, for driving an output application. Several pawls may engage teeth of the ratchet and be magnetized in turn periodically to increase the speed of the wheel without increasing the frequency of any one pawl.

The above specificities of the seven embodiments described in detail are not limiting to the scope of the invention and it will be readily seen that many further variations and ramifications of this invention—the direct use of the much larger magnetic normal force instead of tangential force to drive a motor—are possible.

For example, the fixed member described herein may be an externally toothed stator and the driven member described herein may be an externally toothed rotor placed outside the stator. As another example, the fixed member may have an internal cavity having polygonal cross-section the driven member may have a polygonal cross-section having fewer sides than that of the fixed member. As another example, the fixed member may be a screw thread and the driven member a screw. As a further example, the fixed member may be a rack and the driven member may be a pinion.

Pairs of motors may be used together, oscillating as mirror images of each other, in order to balance out the asymmetric forces caused by the eccentric oscillation.

For a fixed member with a cylindrical, internally-toothed cavity and a cylindrical, externally-toothed driven member, a clutch mechanism may be provided in which a spring tends to pull the driven member concentric with the fixed member. When the magnetic field is applied, the driven member is pulled against the fixed member, and the motor operates. When no field is applied, the spring pulls the driven member concentric with the fixed member and no motor operation or wear takes place.

Furthermore, using balanced forces and magnetic bearing techniques, this clutch mechanism could be used to operate the motor as an induction motor at high speed, to provide low torque, and as the motor of the present invention at low speed, to provide high torque. The spring would be used to pull the driven member out of mechanical contact with the fixed member at low speeds, and balanced forces and known bearing techniques applied to cause the driven member to spin within the fixed member without mechanical contact, as in a regular induction motor. At low speeds, magnetic fields would be applied to overcome the force from the spring, bringing the driven member into mechanical contact with the fixed member and causing the motor to operate as in the first embodiment of the present invention.

Furthermore, eccentric bearings may be used as a clutch. Thus the eccentric bearing approach of FIG. 3, having rotor bearings and carrier bearings, requires that the distance between the centers of adjacent bearings is the same for the rotor bearings as for the carrier (or stator) bearings. In this condition, the oscillating element is constrained to follow a circular path. This is the case in normal operation. However, if the distance between centers of adjacent rotor bearings is different than that for adjacent carrier bearings, the rotor will be locked in place and unable to move. Thus a clutch mechanism may comprise means for adjusting the carrier bearing supports such that in a first position, the distances between centers of adjacent bearings are equal to that for the rotor, and in a second position, the distances between centers of adjacent bearings are not equal to that for the rotor. Thus in the first position, the motor operates normally, and in the second position, it does not move. Furthermore, by adjusting the bearings into a third position, the rotor may be completely disengaged from the stator or carrier, that is, the motor will operate in a ‘free spin mode’. An advantage of this clutch mechanism is that a clutch can be provided without adding any large components to the motor. A further advantage is that the motor can be easily switched from normal operation to locked, for example for braking, and to free spin, for example in an emergency to avoid overheating when an aircraft or vehicle to which the motor is attached is unable to move forward. Said means for adjusting the bearing supports may be any mechanism usable for this purpose.

As a further possibility, a cam ring may be used as shown in FIG. 24. The cam ring 49 is coupled to an output shaft 6. Solenoids 50 or magnetic windings are arranged radially around the cam ring. Magnetic arms are positioned adjacent to the solenoids or windings such that magnetizing a winding causes the adjacent arm to be repelled by and move away from the solenoid or winding. Rollers are rotatably mounted on the ends of the arms distant from the solenoids or windings such that when repelled, the roller pushes the cam ring. Each solenoid or winding is magnetized in turn, creating a magnetic field that circumnavigates the cam ring, such that the rollers push on the cam ring in turn around its circumference, to turn the cam ring. Since the cam ring is coupled to the output shaft 6, it transmits rotation to the output shaft. The solenoids or windings 50 may alternatively be positioned at an angle to the radial direction, and may be inside or outside the cam ring, or a combination thereof.

As a further alternative, the invention may comprise a fixed member comprising at least one magnetic winding, having an internal cavity and a driven member comprising magnetically conductive materials, said driven member being able to move within, said fixed member, wherein magnetic normal force is induced in said fixed member periodically, whereby said driven member is periodically moved by magnetic force with respect to said fixed member, whereby any sort of periodic motion is produced. The motion may be oscillatory, reciprocal, or motion of any other shape or form.

In all of the above wherein magnetic normal force has been used to drive a high frequency oscillation which is converted into low speed, high torque rotation, the rotor both oscillated and rotated. As a final alternative for this invention, the rotor may be centrally mounted on the output shaft and may rotate slowly, without oscillating, and the stator may oscillate about the rotor. This simplifies the bearings arrangements, since the rotor is on standard bearings which permit it to rotate, and these same bearings may support the output, e.g. the driven wheel. The stator may be mounted on eccentric bearings and may oscillate eccentrically. The eccentric stator bearings may be mounted on a stationary plate, and their position may be adjustable. In particular, the eccentric stator bearings may be adjustable in and out radially, enabling the stator to be selectively centered in the rotor (disconnecting the bearings) or driven against the rotor (connecting the bearings). Adjusting the bearings in this manner may be used to provide a clutch for the motor.

It will be readily appreciated that many further arrangements of apparatus will also comprise embodiments of this invention, and the scope of the invention should be determined by the appended claims.

1. A motor comprising:
(a) at least one fixed member comprising at least one magnetic winding, having an internal cavity;
(b) at least one driven member located inside said fixed member, comprising magnetically conductive materials, said driven member being able to move within said fixed member;
(c) constraining means for constraining said driven member to a path of movement with respect to said fixed member;
wherein magnetic normal force is induced in said fixed member periodically, whereby said driven member is periodically moved around said path by magnetic force, whereby rotary motion is produced.

2. The motor of claim 1 wherein:
(a) said fixed member is a stator having a magnetic core and magnetic windings, said cavity of said stator being cylindrical;
(b) said at least one driven member is a cylindrical rotor having an outer diameter significantly smaller than an inner diameter of said stator, and being mounted eccentrically with respect to said stator;
(c) said induced magnetic normal force rotates around a circumference of said stator, such that a contact patch between said rotor and said stator rotates around an inner circumference of said stator; and
(d) said constraining means comprise transmission means for absorbing oscillation and transmitting rotation;
said motor further comprising an output shaft concentric with said stator;
whereby said rotor oscillates and rotates and whereby said transmission means absorbs said oscillation of said rotor and transmits said rotation of said rotor to said output shaft.

3. The motor of claim 2 wherein:
(a) said rotor comprising a first gearing element having gear teeth;
(b) said stator comprising a second gearing element having gear teeth;
(c) said first gearing element having slightly fewer gear teeth than said second gearing element;
whereby gear separation forces produced by a mechanical action of said gearing elements are overcome by said constraining means and large torques can be sustained without slip.

4. The motor of claim 3 wherein said gear teeth of said stator are formed into the face of the internal cavity of said stator.

5. The motor of claim 3 wherein magnetic regions of said rotor and stator are spatially distinct from said gear teeth of said rotor and stator such that said magnetic regions comprise a first layer and said gear teeth comprise a second layer.

6. The motor of claim 5 having more than one layer of magnetic regions and/or more than one layer of gear teeth, said magnetic regions and said gear teeth being arranged in alternate layers.

7. The motor of claim 1 wherein said windings of said fixed member comprise at least one solenoid.

8. The motor of claim 2 wherein said windings of said stator comprise at least two solenoids arranged radially around said stator.

9. The motor of claim 2 wherein:
(a) said rotor comprises a ring gear comprising a hollow, externally toothed cylinder having a cylindrical, internally toothed cavity;
(b) said motor additionally comprising an output gear concentrically mounted on an output shaft concentric with said stator, inside said ring gear, wherein said output gear has an outer diameter substantially smaller than an inner diameter of said ring gear, said output gear being externally toothed;
whereby said ring gear rotor transmits rotation but not oscillation to said output gear.

10. The motor of claim 9 additionally comprising decoupling means pulling said rotor concentric with said stator, whereby said stator is decoupled from said output shaft, whereby said motor can operate in magnetic normal force mode for low speed/high torque operation and other modes for high speed operation.

11. The motor of claim 2 additionally comprising:
(a) a small, externally toothed gear non-rotationally and concentrically mounted on said rotor;
(b) an internally toothed output gear, concentrically mounted on said output shaft, concentric with said stator,
whereby oscillation of said rotor is absorbed and rotation of said rotor is transmitted to said output shaft.

12. The motor of claim 1 wherein:
(a) said fixed member is a stator, and said internal cavity of said fixed member is a cylindrical cavity;
(b) said driven member is a rotor and comprises a flexible spline; and
(c) said magnetic normal force rotates in two locations around the circumference of said stator, such that two contact patches between said rotor and said stator, 180 degrees apart, rotate around the inner circumference of said stator;
whereby rotation is transmitted to an output shaft.

13. The motor of claim 12 wherein said flexible spline has external gear teeth and said cylindrical cavity has internal gear teeth.

14. The motor of claim 1 wherein:
(a) said fixed member is a stator having a cylindrical internal cavity;
(b) said at least one driven member comprises planet gears comprising magnetic materials;
(c) said motor additionally comprising a sun gear concentrically mounted on said stator, wherein said planet gears engage with said sun gear;
(d) said internal cavity of said stator, said planet gear rotors and said sun gear have gear teeth;
whereby said stator, said rotors and said sun gear comprise a planetary gear system;
wherein said magnetic normal force rotates in at least one location, corresponding to a number of planet gear rotors, around a circumference of said stator, such that a contact patch between said stator and each of said planet gear rotor rotates around an inner circumference of said stator; whereby rotation is transmitted to said sun gear.

15. The motor of claim 1 wherein:
(a) said at least one fixed member comprising two identical stators, each with a magnetic core and magnetic windings, said cavity of said stators being cylindrical, said stators being positioned substantially parallel and concentric;
(b) said at least one driven member comprising two identical cylindrical rotors having outer diameters significantly smaller than an inner diameter of said stators, each being located inside one stator and eccentrically mounted with respect to a stator in which it is located;
(c) said magnetic normal force rotates around a circumference of each said stator, such that a contact patch, one between each said rotor and said stator, rotates around an inner circumference of each said stator, such that said contact patches are 180 degrees out of phase;
said motor further comprising:
(a) an output shaft concentric with said stators;
(b) an internally toothed output gear, concentrically mounted on said output shaft, parallel and concentric with said stators, between said stators;
(c) a small, externally toothed gear non-rotationally, concentrically mounted on each said rotor, positioned such that each small gear engages said output gear;
whereby said rotors oscillate and rotate; whereby oscillation of said rotor is absorbed by said output gears and rotation of said rotors is transmitted by said small gears to said output shaft; whereby forces in said motor are balanced.

16. The motor of claim 1 wherein:
(a) said fixed member comprises a solenoid;
(b) said driven member comprises an arm able to fit inside said solenoid; comprising:
(1) a pawl pivotally connected to a first end of said arm;
(2) a ratchet having teeth, concentrically mounted on said output shaft;
(3) a spring connected to a second end of said arm;
wherein said pawl engages the teeth of said ratchet;
(c) magnetic normal force is periodically induced in said solenoid, whereby said arm is periodically pulled towards and inside said solenoid when said force is being induced, and pulled towards said spring when said force is not being induced,
whereby said pawl oscillates and turns said ratchet, whereby rotation is transmitted to said output shaft.

17. The motor of claim 1 additionally comprises a transmission means, said transmission means comprising:
(a) rotor bearings;
(b) carrier bearings;
(c) adjustable carrier bearing supports;
further comprising a clutch mechanism comprising means for adjusting bearing supports of fixed element bearings such that in a first position, the distances between centers of adjacent bearings are equal to that for the oscillating element, and in a second position, the distances between centers of adjacent bearings are not equal to that for the oscillating element.
